(19) United States
(12) Patent Application Publication
(10) Pub. No.: US 2005/0156361 A1
(43) Pub. Date: Jul. 21, 2005

(54) Methods for producing complex ceramic articles

(75) Inventors: John E. Holowczak, South Windsor, CT (US); Wayde R. Schmidt, Pomfret Center, CT (US); Marc R. Sauerhoefer, Broad Brook, CT (US)

Correspondence Address: McCormick, Paulding & Huber LLP, CityPlace II, 185 Asylum Street, Hartford, CT, 06103-3402, US

(73) Assignee: United Technologies Corporation, Hartford, CT (US)

(21) Appl. No.: 10/761,908

(22) Filed: Jan. 21, 2004

(51) Int. Cl. B29C 33/40; B29C 35/08; B29C 41/02

(52) U.S. Cl. 264/603; 264/308; 264/401; 264/497; 264/113; 264/219; 264/28; 264/87

(57) ABSTRACT

Ceramic articles, particularly ceramic cores and molds for an investment casting and combinations of ceramic cores and molds are produced using temporary molds, patterns or models made by a rapid prototyping or solid free-form manufacturing process. The molds, cores and patterns are contacted with ceramic slurry, which is then solidified by lowering the temperature of the slurry. What was liquid in the original slurry is then removed by sublimation leaving behind a ceramic article having a configuration, which is defined by the temporary tooling. The ceramic article so produced may be densified by sintering, and is used in a casting process.

### BACKGROUND OF THE INVENTION

1. Field of the Invention

The present invention relates to methods of producing complex ceramic articles, particularly cores, molds, and core-mold combinations for use in producing metallic castings.

2. Background Information

Casting is used to produce complex metallic articles, including articles having internal cavities or passages. Investment casting is commonly used for the fabrication of high temperature alloy components such as those used in gas turbine engines. Many gas turbine components, especially turbine airfoils and combustor components, require internal cavities and passages through which cooling gas can be flowed to maintain the temperature of the component within safe limits.

The cooling gas used comes from the engine compressor, and minimizing the amount of compressor air that is used for cooling can increase engine efficiency. The complexity of the internal cavities and passages used in aerospace gas turbine components has increased in order to increase cooling efficiency. Many of these schemes, while very efficient, are presently difficult to implement. In addition, gas turbine designers are interested in cooling schemes which require core geometries that cannot be produced using current methods of core production.

One such cooling geometry is shown in FIG. 1 taken from U.S. Pat. No. 6,247,896, which patent is hereby incorporated herein by reference. FIG. 1 is a diagrammatic sectional view of a microcircuit-cooling configuration in which cooling air spirals through a cooling fluid microcircuit 10 that is cast within the wall 12 of a gas turbine component. The wall 12 has an inner surface 14 located within the component and an outer surface 16 which forms the outer surface 16 of the component, the inner portion of the component is supplied with pressurized cooling air. The cooling air enters the circuit 10 at entry orifice 18, spirals through the microcircuit 10 and exits to the exterior wall surface 16 at exit orifice 20. This flow of cooling air within the component wall provides highly efficient cooling. The wall thickness of a typical modern gas turbine airfoil will range from about 0.020 inch to about 0.080 in., preferably about 0.040 in., and the number of spiral microcircuits per square inch will desirably range from about 1, preferably about 10, to about 100.

The passage or circuit 10 shown in FIG. 1 is distinguishable from conventionally produced cooling holes in several respects. Prior art cooling holes are produced by drilling process including laser drilling, EDM drilling and ECM drilling. Therefore, prior cooling holes, excluding of course the holes described in U.S. Pat. No. 6,247,896, are restricted to being relatively straight. This means that air flowing through such holes does not turn as it passes through the hole. The specific microcircuit passage shown in FIG. 1 contains about ten right angle turns, meaning that air passing through the microcircuit is turned a total of about 900 degrees. The turning causes turbulence in the air flow and increases the cooling effectiveness.

In addition, prior drilled cooling holes have a length that is comparable to the thickness of the part wall. While holes are often drilled at a slant, relative to the thickness dimension of the part, the hole length is invariably less than two times (2×) the part thickness. Consideration of FIG. 1 reveals that the length of the microcircuit passage 10 can be at least ten times (10×) the part thickness.

Finally, the microcircuit passage 10 shown in FIG. 1 lies on a plane that is substantially parallel to the plane of the part wall. Such a passage running parallel to the wall cannot be produced by drilling.

The term “complex geometry” will be used to describe a passage that cannot be produced by drilling. Complex geometry passages will have at least one of the following features:
1. a change in passage direction of more than about thirty (30) degrees within the part;
2. a length that is more than about three times (3×) the part thickness;
3. a portion of the passage lies in a plane that is approximately parallel to the part surfaces;
4 a change in passage shape within the part;
5. a non-monotonic change in cross sectional area within the part;
6. the passage branches or joins another passage within the part.

The term “complex geometry” will also be used to describe the portion of the predecessor core that forms the passage. A complex geometry core portion that joins two larger ceramic bodies will also be referred to as a ligand.

There is currently no practical method to produce such passages in a thin walled (less than 0.10 in. thick) cast article except by casting. Consequently, a mold/core combination with ceramic features, ligands, which connect the mold and the core is required. The ligands produce the complex cooling passages. It will be appreciated that the fabrication of a ceramic mold, core and ligands to produce a component having a large number of small, intricate cooling circuits within the component wall is a formidable task. It is highly preferred that the mold, core, and ligands be produced integrally since the task of locating and attaching hundreds of ligands to produce the core/mold/ligand assembly would be time consuming, tedious, and it would be highly unlikely that a flaw free assembly could be produced.

Conventional methods of core production, usually by injection molding a viscous ceramic slurry into split die molds, cannot produce the geometry required for the development of microcircuit cooling passages; the nature of the spiral micro-circuits precludes the use of conventional core fabrication process. The present application describes a method to produce such complex core geometries.

U.S. Pat. No. 5,824,250 describes a gel cast molding technique using fugitive molds to produce solid ceramic components.

U.S. Pat. Nos. 4,575,330, 5,136,515 and 5,740,051 which are incorporated herein by reference, describe various approaches to produce three-dimensional objects by the deposition of thin layers of material. These methods, and others like them are called “rapid prototyping” and “solid free form” manufacturing processes.

The use of freeze casting to produce ceramic articles is shown in U.S. Pat. No. 4,341,725, which is incorporated herein by reference.

### SUMMARY OF THE INVENTION

The present invention includes a process for producing complex ceramic articles, including ceramic cores, molds and combined core molds which can be used to produce cast metallic articles, including those having complex internal cavities and passages.

Temporary, disposable or fugitive tooling, including core, molds, patterns and forms made of wax, plastic or similar materials, are produced using a rapid prototyping process, which is controlled by a computer or controller, permitting the automated production of such tooling, hereinafter referred to as “temporary tooling”. Because the geometric data which defines the temporary tooling, and ultimately the ceramic articles and investment castings, exists in numeric form and/or as a mathematical model, changes can be readily and economically accomplished. The temporary tooling may be produced using a variety of rapid prototyping/solid free form manufacturing processes. These processes generally produce an article by sequential application of thin layers of material that are adhered to each other. Articles having complex geometries can be produced. The term “rapid prototyping” will be used herein to denote all systems which produce complex articles using a layer-by-layer deposition technique.

Once the temporary tooling has been produced, it is used to produce the ceramic core, mold, or core-mold. The method of producing the ceramic core, mold or core-mold in the invention, is generically referred to as freeze casting. The freeze casting method employs a slurry of ceramic particles in a liquid carrier, which is used to fill the mold or surrounded the model. The slurry is solidified by cooling to a low temperature. The mold, core or mold-core is removed and the solidified ceramic slurry article is then treated to remove substantially all of the original liquid carrier. A sublimation or vacuum de-watering process accomplishes this removal. The dried ceramic material may be sintered to improve its mechanical properties. The resultant article is then used as a core, a mold or a combination core and mold to produce a metallic casting.

In one embodiment, a fugitive mold which has been fabricated by rapid prototyping is used to form a ceramic core, which can subsequently be used to produce a hollow metallic component such as a gas turbine airfoil.

In another embodiment, a temporary pattern is used to produce a hollow ceramic casting mold.

In yet another embodiment, a rapid prototype-produced fugitive part pattern has the same internal and external geometry as the metallic part to be cast. The temporary pattern is surrounded by ceramic slurry, which is solidified. In this embodiment a combination core-mold is produced. Multiple complex passages may connect the inner and outer surfaces of the temporary pattern and the resultant ceramic article will have ceramic ligands, which correspond to the passages in the temporary pattern, and which extend between and connect the core and the mold and will ultimately form complex cooling passages in the cast article.

Those skilled in the art will appreciate that in the design and production of castings various factors must be accounted for; materials expand when heated, molten metal shrinks when it solidifies, metal and ceramic articles are subject to warpage during thermal changes; and porous ceramic articles usually shrink when sintered. Since these factors are generally known and understood by those skilled in the art they will not be discussed except to note that they will generally be accounted for in the numeric data or model that is used in the rapid prototyping process.

### BRIEF DESCRIPTION OF THE DRAWINGS

FIG. 1 is a diagrammatic sectional view of a microcircuit cooling configuration.

FIG. 2A is a diagrammatic illustration of a mold embodiment.

FIG. 2B is a diagrammatic illustration of a molded article.

FIG. 3A is a planar front view of a casting core.

FIG. 3B is a planar top view of a casting core.

FIG. 4A is a diagrammatic illustration of a mold embodiment.

FIG. 4B is a diagrammatic illustration of a molded article.

FIG. 5A is a diagrammatic illustration of a mold embodiment.

FIG. 5B is a diagrammatic illustration of a mold embodiment.

FIG. 6A is a diagrammatic illustration of a mold embodiment.

FIG. 6B is a diagrammatic illustration of a molded article.

### DETAILED DESCRIPTION OF THE INVENTION

The present invention provides a method for manufacturing complex ceramic articles including configurations that cannot be produced using prior methods.

Temporary tooling materials, also termed disposable materials, will generally contain substantial amounts of plastics, waxes, and combinations thereof.

A requirement of the rapid prototype-produced mold pattern or model, as used in the invention process, is that it be removable without damaging the freeze cast ceramic article that has been formed within or around the mold. Solvent dissolution, and thermal treatments to melt, decompose, or react (oxidize) rapid prototype material may be used.

One embodiment of the invention uses a temporary mold, produced by rapid prototyping, containing a cavity, to form a complex ceramic article by filling the mold cavity with a ceramic slurry. After appropriate treatment the ceramic article can be used, inter alia, as a casting core to produce a hollow metallic cast article, such as a gas turbine airfoil or combustor component.

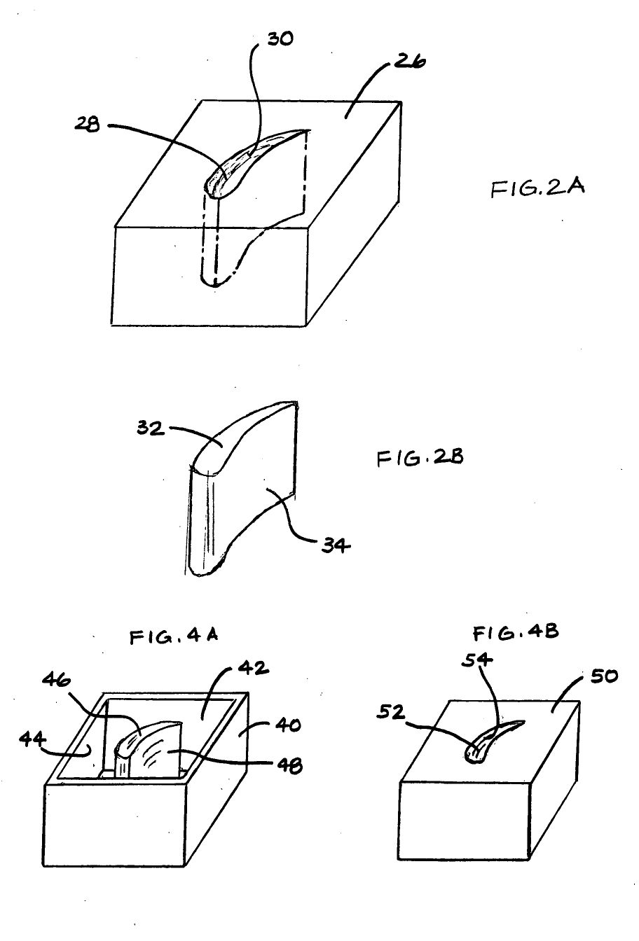

FIGS. 2A-2B illustrates the fabrication of a ceramic article such as a core for producing a hollow cast article. FIG. 2A shows a disposable mold 26, made of a disposable material by a rapid prototyping process and containing a shaped cavity 28. The cavity 28 is defined by surface 30. Cavity 28 may be filled with a ceramic slurry that may be solidified by cooling to freeze the slurry carrier. After removal of mold 26 and removal of the frozen carrier from the frozen slurry, and further optional processing, ceramic article 32 (see FIG. 2B) results. The size and shape of ceramic article 32 is essentially that of original cavity 28. The ceramic article 32 can be used as a core to produce a cast metal article having an internal cavity or passage. Thus, the shape of cavity 28, produced using rapid prototyping, defines the exterior shape of article 32, and ultimately defines the shape of a cavity within a metal casting.

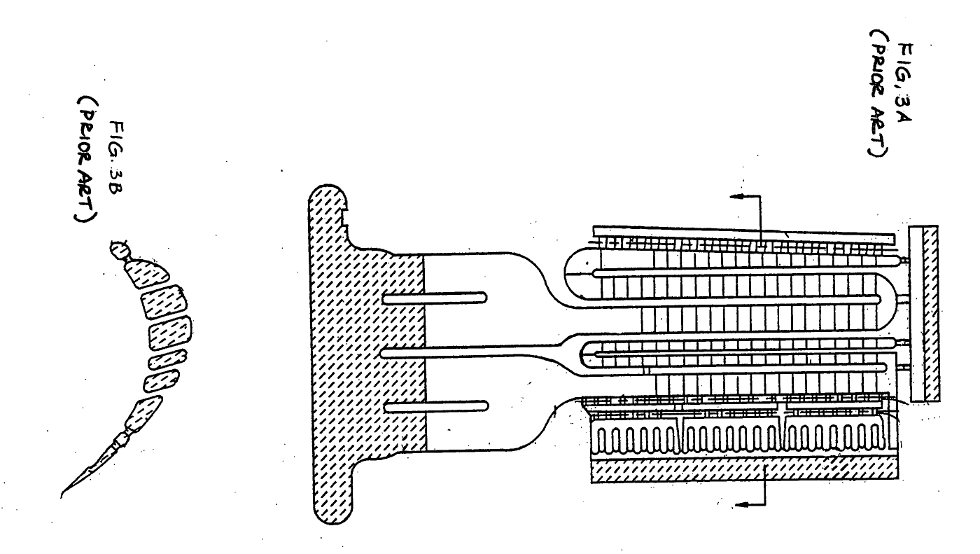

While FIG. 2A illustrates a simple core shape, the same process can be used to make cores of considerable complexity. FIGS. 3A-3B are taken from U.S. Pat. No. 5,599,166, and they depict an exemplary complex core which can be produced using the above-described process.

A second embodiment of the invention provides a core-mold for producing metallic castings containing cavities and/or passages. In this embodiment, a container having a cavity is provided with an internal feature produced by rapid prototyping. The feature has an external configuration that corresponds to the outer geometry desired in the cast product. The cavity surrounding the feature is filled with ceramic slurry that is then frozen. The container and the feature are removed to produce a ceramic mold having a shaped cavity.

FIGS. 4A-4B illustrate an arrangement to form a ceramic mold. In FIG. 4A, container 40 contains a cavity 42 which is defined in part by the inside wall surface of 44 of container 40. Container 40 may be designed to be reused, or it may be disposable, perhaps made by rapid prototyping. Located within cavity 42 is feature 46 formed from a disposable material by a rapid prototyping process; feature 46 has an exterior surface 48 that corresponds to the shape of the cavity desired in the ceramic mold.

Ceramic mold 50 shown in FIG. 4B is produced by filling cavity 42 with a ceramic slurry, solidifying the slurry by freezing, removing container 40 and feature 46, and then removing the slurry carrier by sublimation or dewatering. Mold 50 contains cavity 52, defined by surface 54, whose configuration has been defined by surface 48 of disposable feature 46. Again, the rapid prototyping process defined the surface 48 of disposable feature 46, and indirectly defined the surface 54 of cavity 52, and the external surface of a casting produced using mold 50.

A third embodiment of the invention provides a combination core and mold for use in producing metallic articles. In this embodiment, the rapid prototype pattern has an internal cavity corresponding to the desired core configuration, and an outer configuration corresponding to the outer geometry desired in the cast product. The rapid prototype pattern replicates the geometry of the desired part including fine details such as cooling passages.

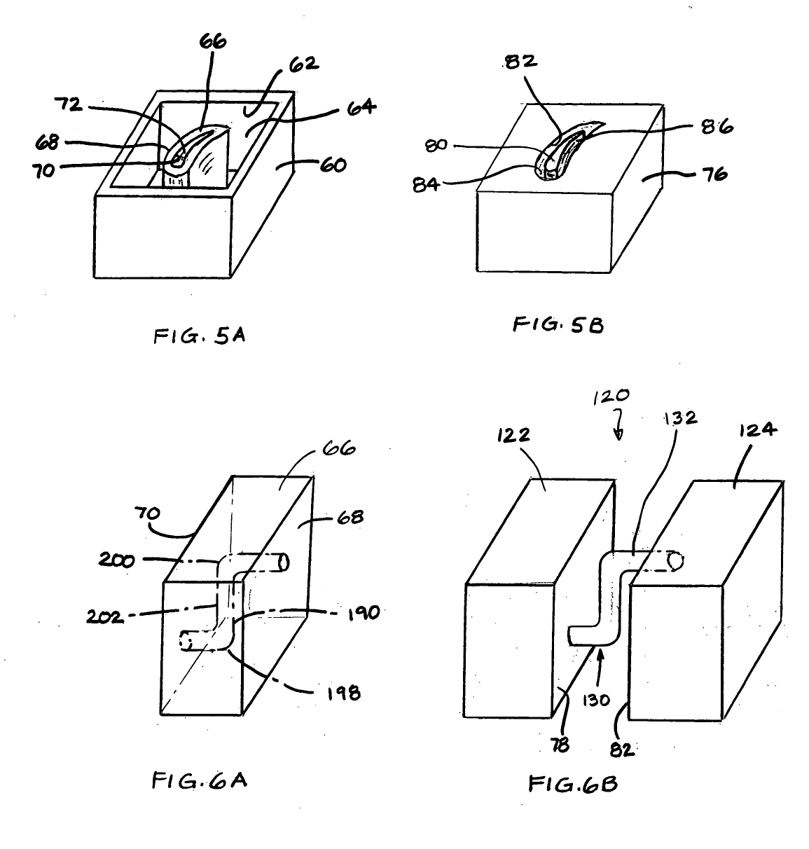

FIGS. 5A-5B show the formation of a combined core-mold for the casting of hollow articles. Referring to FIG. 5A, a hollow container 60 is provided and may be a reusable (multi part) container, or may be made of a disposable material, and, if so, may be made by rapid prototyping. Container 60 has an inner surface 62 that defines the outer surface of cavity 64. Cavity 64 contains a disposable feature 66 that is produced from a disposable material by a rapid prototyping process. Disposable feature 66 has an external surface 68 and an interior surface 70 that defines interior cavity 72. Cavities 64 and 72 are filled with a ceramic slurry that is solidified by freezing and then has its frozen liquid carrier removed. The container 60 and disposable feature 64 are then removed. The result, shown in FIG. 5B, is a ceramic mold 76 containing cavity 84 and ceramic core 80. Cavity 84 is defined by the inner surface 86 and outer surface 82 of core 80.

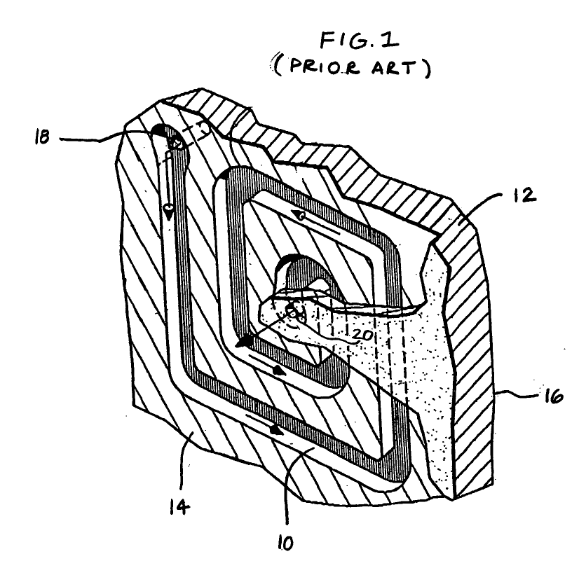

FIGS. 6A-6B illustrate the formation of a cooling passage having a geometry of the type shown in FIG. 1, although shown in simplified form. FIG. 6A is a portion of disposable feature 66 and is defined in part by outer surface 68 and inner surface 70. The portion contains hollow passage 190 that is defined by inner surface 192. Passage 190 connects outer surface 68 with inner surface 70 and would allow the flow of a fluid between these surfaces. Passage 190 is formed during the rapid prototyping process.

Passage 190 has a complex shape, including two 90-degree turns, 198 and 200, totaling 180 degrees, a fluid flowing through passage 190 would be turned about 180 degrees. Passage 190 also contains a segment 202, which lies between turns 198 and 200, which lies in a plane that is approximately parallel to surfaces 68 and 70 of portion 100. The length of passage 190 is at least five (5) times the distance between surfaces 68 and 70. These features of passage 190, including a total fluid turning in excess of 30 degrees, at least one passage segment lying in a plane substantially parallel to the surfaces 68 and 70, and a passage length in excess of about three (3) times the spacing between the surfaces 69 and 70 are all cooling passage features that improve cooling efficiency and cannot be produced by conventional drilling processes in an article having a thickness of less than about 0.100 in.

As described above with respect to previous invention embodiments, surfaces 68 and 70 are contacted by the ceramic slurry. The ceramic slurry must also fill passage 190. Process steps including vibration of container 60, feature 66 and the ceramic slurry along with variations of external pressure may be employed to ensure that the ceramic slurry completely fills passage 190. A differential pressure may also be provided between surfaces 68 and 70 to cause the slurry to flow through passage 190. The ceramic slurry is hardened by freezing and the container 60 and disposable portion 66 are removed. The frozen slurry carrier is removed leaving a ceramic assembly 120 shown in FIG. 6B.

The ceramic assembly 120 comprises an inner ceramic portion 122 partly defined by surface 78 and outer ceramic portion 124 partly defined by surface 82. A ceramic ligand 130 extends between surfaces 78 and 82. The ceramic ligand has an outer surface 132 and a geometry that is the same as the geometry of passage 190.

The ceramic slurries that are used will comprise major amount of ceramic particles in a liquid carrier. The carrier will usually be aqueous. The ceramic particles may be chosen from a wide range of ceramics including oxides, nitrides, carbides, oxy-nitrides, oxy-carbide and carbo nitrides. Slurries based on oxide ceramics will be preferred for casting of superalloy components, and slurries based on silica, alumina, yttria, hafnia, zirconia and mixtures thereof will be particularly preferred. Ceramic particle sizes of less than about 100 microns are desirable and sizes from about 0.1 to 50 microns are preferred.

The relative quantities of ceramic particles and carrier will be selected to produce the required slurry viscosity. It is generally desirable to minimize the amount of carrier to maximize the density of the ceramic article after slurry removal.

A variety of other materials may be added to the slurry including cryo protective additives to reduce the formation of large ice crystals. Exemplary cryo protective materials include dimethyl sulfoxide, urea, and glycols. Colloidal ceramics, such as colloidal silica, or alumina may be added to keep the ceramic particles in suspension, to improve green strength, and to aid sintering. Dispersants/deflocculants may also be added.

The appropriate slurry composition for a particular application will be fairly specific to that application. It is well within the ability of one skilled in the art to design an appropriate slurry.

The slurry can be solidified by cooling and after the ceramic slurry has been solidified, it is maintained at a low temperature and the original liquid carrier material removed by sublimation, or by vacuum de-watering. For aqueous based carriers, sublimation can be performed at 10⁻³ Torr pressure and temperatures below about 10° F. The rate of sublimation increases with increased temperature and decreased pressures. Pressures of 10⁻²-10⁻⁴ Torr and temperatures up to approximately room temperature are generally appropriate.

Removal of the slurry carrier from the solidified ceramic slurry article can be accomplished by keeping the solidified article at a temperature below the solidification temperature of the ceramic slurry for the entire time required to remove the original carrier. Alternately the carrier removal may be performed at a temperature below the slurry solidification temperature until a surface layer of dried (carrier free) ceramic has formed which is thick enough to retain the article shape. The temperature may then be gradually raised to the freezing temperature, allowing sublimation to occur at a higher rate.

In most cases, the removal of the solidified carrier from a solidified ceramic slurry can be accelerated by removing mold and/or model and/or pattern to present a maximum surface area of the solidified ceramic slurry to the atmosphere.

The mold/core/pattern may be removed by a technique that is suitable for the rapid prototyping material employed. In the case of stereolithography in which a solid polymer is produced is by ultraviolet polymerization of a liquid polymer resin, removal can be accomplished by thermal and/or chemical means including heating, combustion, or dissolution in a solvent appropriate to the resin.

After the carrier has been removed from the solidified ceramic material, the resultant ceramic article will be porous. In this condition, the article may be machined if needed. While the porous article may be useful for some applications, it will usually be sintered to increase its density and improve its mechanical properties. The sintering time and temperature are selected based on the ceramic constituents and particle size.

Although this invention has been shown and described with respect to the detailed embodiments thereof, it will be understood by those skilled in the art that various changes in form and detail thereof may be made without departing from the spirit and the scope of the invention.

1. Method for producing ceramic articles, comprising the steps of:
a. using a rapid prototyping process to produce a disposable mold having a cavity which has the shape of the desired ceramic article;
b. filling said cavity with a ceramic slurry which includes a liquid carrier;
c. cooling the slurry filled mold cavity to solidify said slurry;
d. removing said disposable mold; and
e. removing substantially all of the original liquid carrier from said solidified slurry to produce a ceramic article.

2. Method as in claim 1 wherein said slurry is aqueous based.

3. Method as in claim 1 wherein said slurry consists essentially of (by wt.):
a. from about 70% to about 90% ceramic particles
b. an amount of at least one cryoprotectant material sufficient to suppress the formation of large crystals during solidification
c. from about 10% to about 30% of a liquid suspension of at least one colloidal ceramic material,
d. up to about 5% of other additives
e. balance essentially water.

4. Method as in claim 1 wherein the disposable mold is made of a material selected from the group consisting of polymers, waxes, plastics and hard particles coated with a material selected from the group consisting of polymers, waxes, plastics and mixtures thereof.

5. Method as in claim 1 wherein the disposable mold is removed prior to the removal of the original liquid carrier.

6. Method as in claim 1 wherein the removal of the original liquid carrier is performed prior to the removal of the disposable mold.

7. Method as in claim 1 wherein the original carrier is removed by a process selected from the group consisting of sublimation, vacuum dewatering and combinations thereof.

8. Method as in claim 1 wherein the ceramic article is treated by sintering improve its mechanical properties.

9. Method for producing a ceramic mold for casting metallic parts, having desired exterior shapes, comprising the steps of:
a. using a rapid prototyping process to produce a disposable pattern whose external shape corresponds to the desired external shape of the metallic part and placing the temporary pattern in a container,
b. filling the container with a ceramic slurry,
c. cooling the slurry filled container to solidify said slurry,
d. removing said disposable pattern from said solidified slurry, and
e. removing substantially all of the original liquid carrier from said solidified slurry.

10. Method as in claim 9 wherein said slurry is aqueous based.

11. Method as in claim 9 wherein said slurry consists essentially of (by wt.):
a. from about 70% to about 90% ceramic particles,
b. an amount of at least one cryoprotectant material sufficient to suppress the formation of large crystals during solidification,
c. from about 10% to about 30% of a liquid suspension of at least one colloidal ceramic material,
d. up to about 5% of other additives, and
e. balance water.

12. Method as in claim 9 wherein the disposable pattern is made of a material selected from the group consisting of polymers, waxes, plastics and hard particles coated with a material selected from the group consisting of polymers, waxes, plastics and mixtures thereof.

13. Method as in claim 9 wherein the disposable pattern is removed prior to the removal of the original liquid carrier.

14. Method as in claim 9 wherein the removal of the original liquid carrier is performed prior to the removal of the disposable pattern.

15. Method as in claim 9 wherein the original liquid carrier is removed by a process selected from the group consisting of sublimation, vacuum dewatering and combinations thereof.

16. Method as in claim 9 wherein the ceramic article is sintered.

17. Method for producing an integral ceramic core mold for casting metallic parts having an external shape and having at least one internal passage having an internal shape, including the steps of:
a. using a rapid prototyping process to produce a disposable pattern whose external shape corresponds to the desired external configuration of the metallic part and an internal passage shape corresponds to the shape of the desired metallic part internal passage,
b. placing said disposable model in a container,
c. filling said container and said internal cavity with a ceramic slurry,
d. cooling the slurry filled container and cavity to solidify said slurry;
e. removing said disposable model from said solidified slurry, and
f. removing substantially all original liquid carrier from said solidified slurry.

18. Method as in claim 17 wherein said slurry is aqueous based.

19. Method as in claim 17 wherein said slurry consists essentially of (by wt.):
a. from about 70% to about 90% ceramic particles,
b. an amount of at least one cryoprotectant material sufficient to suppress the formation of large crystals during solidification,
c. from about 10% to about 30% of a liquid suspension of at least one colloidal ceramic material,
d. up to about 5% of other additives
e. balance essentially water.

20. Method as in claim 20 wherein the disposable pattern is made of a material selected from the group consisting of polymers, waxes, plastics and hard particles coated with a material selected from the group consisting of polymers, waxes, plastics and mixtures thereof.

21. Method as in claim 17 wherein the disposable pattern is removed prior to the removal of the original liquid carrier.

22. Method as in claim 17 wherein the removal of the original liquid carrier is performed prior to the removal of the disposable pattern.

23. Method as in claim 17 wherein the removal of the original liquid carrier is performed at a temperature below the solidification point of the ceramic slurry.

24. Method as in claim 17 wherein the ceramic article is by sintered improve its mechanical properties.

25. A method as in claim 17 in which said pattern includes a plurality of channels which extend through the model and connect the external surface of the model with the internal surface of the model.

26. Method as in claim 17 in which at least one of said channels has a complex geometry.

27. A ceramic assembly that includes at least two ceramic articles connected to each other by at least 10 integral ceramic ligands, wherein at least one ligand has a complex geometry.

28. A ceramic assembly as in claim 27 wherein one of the ceramic articles is located at least partially within a cavity within another ceramic article.
